(19) United States
(12) Patent Application Publication
(10) Pub. No.: US 2016/0070634 A1
(43) Pub. Date: Mar. 10, 2016

(54) SYSTEM AND METHOD FOR SYSTEM-ON-A-CHIP SUBSYSTEM TRACE EXTRACTION AND ANALYSIS

(71) Applicant: QUALCOMM INCORPORATED, SAN DIEGO, CA (US)

(72) Inventors: MARTYN RYAN SHIRLEN, WAKE FOREST, NC (US); VICTOR WONG, SAN DIEGO, CA (US)

(21) Appl. No.: 14/479,231

(22) Filed: Sep. 5, 2014

(51) Int. Cl. G06F 11/34; G06F 1/32

(52) U.S. Cl. CPC G06F 11/3495; G06F 1/3206

(57) ABSTRACT

Systems and methods for external access detection and recovery in a subsystem of a system-on-a-chip (SoC) in a portable computing device (PCD) are presented. In operation, a subsystem of the SoC is operated independently of the rest of the SoC, such as when the SoC is in a non-functional or low power mode or state. The subsystem comprises a hardware agent in communication with a trace buffer. While the subsystem is operating independently of the rest of the SoC, the trace buffer captures trace data about the operation of the subsystem. During the operation of the subsystem, in response to identifying a trigger event, the trace buffer stops capturing the trace data, and a wake-up notification comprising a signal from the hardware agent to the SoC is communicated.

### DESCRIPTION OF THE RELATED ART

Devices with a processor that communicate with other devices through a variety of communication media, including wireless signals, are ubiquitous. Mobile devices including portable computing devices (PCDs) may be used to communicate with a variety of other devices via wireless, analog, digital and other means. These mobile devices may include mobile telephones, portable digital assistants (PDAs), portable game consoles, palmtop computers, tablet computers and other portable electronic devices.

In addition to the primary function, PCDs may also be used for downloading and playing games; downloading and playing music; downloading and viewing video; global positioning system (GPS) navigation, web browsing, and running applications such as calendaring and address applications, electronic wallet software, and more.

To accommodate these ever-growing uses and demands for higher performance, modern PCDs typically include a system-on-a-chip (SoC) comprising one or more subsystems or cores (e.g., central processing unit(s), graphics processing unit(s), etc.) for controlling or performing varying functions of the PCD.

Various low or reduced power mode strategies have been implemented to decrease the power consumed by the SoC and/or its subsystems or cores. For example, when the PCD is not being actively used by an end user, some SoCs operate in a reduced or lower power mode which may include periods where the SoC is turned off. In such reduced or lower power modes, the SoC may periodically power up or “wake up” in order to determine a status of the PCD and/or various functionality of the SoC.

However, depending on what functionality the SoC needs to check or determine a status of, powering up the entire SoC may still incur a significant power cost. Accordingly, some SoCs include subsystems or components able to continue operation when the rest of the SoC is in a reduced or low power mode. However, operating such subsystems independently of the rest of the SoC, as a power island for example, can make it difficult to detect, capture, and debug errors in the subsystem when the subsystem is operating in, entering into, or exiting from, such a power island mode.

Thus, there is a need for improved systems and methods to allow debug trace capture, extraction, and analysis for subsystems within an SoC that are operating when the main portion of the SoC is powered down and/or in a low or reduced power mode.

### SUMMARY OF THE DISCLOSURE

Systems and methods for external access detection and recovery in a subsystem of a system-on-a-chip (SoC) in a portable computing device (PCD) are presented. In operation, a subsystem of the SoC is operated independently of the rest of the SoC, such as when the SoC is in a non-functional or low power mode or state. The subsystem comprises a hardware agent in communication with a trace buffer. While the subsystem is operating independently of the rest of the SoC, the trace buffer captures trace data about the operation of the subsystem. During the operation of the subsystem, in response to identifying a trigger event, the trace buffer stops capturing the trace data, and a wake-up notification comprising a signal from the hardware agent to the SoC is communicated.

One example embodiment is a computer system for a system-on-a-chip (SoC) in a portable computing device (PCD), the system comprising: a subsystem of the SoC configured to operate independently of the rest of the SoC, the subsystem comprising: a trace buffer configured to capture a trace data about the operation of the subsystem, and a hardware agent in communication with the trace buffer, the hardware agent configured to identify a trigger event and in response to the identified trigger event: cause the trace buffer to stop capturing the subsystem trace data, and communicate a wake-up notification to the SoC.

Another example embodiment is a computer program product comprising a non-transitory computer usable medium having a computer readable program code embodied therein, said computer readable program code adapted to be executed to implement a method for trace extraction for a subsystem of a system-on-a-chip (SoC) in a portable computing device (PCD), the method comprising: operating the subsystem of the SoC independently of the rest of the SoC, the subsystem comprising a hardware agent in communication with a trace buffer; capturing a trace data about the operation of the subsystem with the trace buffer; identifying a trigger event; and in response to the identified trigger event: stop capturing the subsystem trace data, and communicating a wake-up notification, the wake-up notification comprising a signal from the hardware agent to the SoC.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures. Similarly, for reference numerals with ‘designations, such as 102’, the ‘designation may designate an alternative embodiment for the underlying element with the same reference numerals (but without the ‘designation).

FIG. 1 is a block diagram of an example embodiment of a portable computing device (PCD) in which the present invention may be implemented;

FIG. 2A is a block diagram showing an exemplary embodiment of a system for trace capture, extraction, and analysis by a subsystem of an SoC in a PCD, such as the PCD embodiment illustrated in FIG. 1;

FIG. 2B is a block diagram illustrating aspects of the exemplary system of FIG. 2A;

FIG. 3 is a block diagram of illustrating another exemplary embodiment of a system for trace capture, extraction, and analysis by a subsystem of an SoC in multiple PCDs;

FIG. 4A is a flowchart describing aspects of an exemplary embodiment of a method for providing trace capture, extraction, and analysis by the subsystem of the SoC; and

FIG. 4B illustrates example components capable of performing the aspects of the method illustrated in FIG. 4A.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files or data values that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer-readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “portable computing device” (“PCD”) is used to describe any device operating on a limited capacity rechargeable power source, such as a battery and/or capacitor. Although PCDs with rechargeable power sources have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop or tablet computer with a wireless connection, among others.

In this description, the terms “central processing unit (“CPU”),” “digital signal processor (“DSP”),” “graphics processing unit (“GPU”),” “chip,” “video codec,” “system bus,” “image processor,” and “media display processor (“MDP”)” are non-limiting examples of processing components that may be implemented on an SoC. These terms for processing components are used interchangeably except when otherwise indicated. Moreover, as discussed below, any of the above or their equivalents may be implemented in, or comprised of, one or more distinct processing components generally referred to herein as “core(s)” and/or “sub-core(s).”

In this description, the terms “workload,” “process load,” “process workload,” and “graphical workload” may be used interchangeably and generally directed toward the processing burden, or percentage of processing burden, that is associated with, or may be assigned to, a given processing component in a given embodiment. Additionally, the related terms “frame,” “code block” and “block of code” may be used interchangeably to refer to a portion or segment of a given workload. Further to that which is defined above, a “processing component” or the like may be, but is not limited to being, a central processing unit, a graphical processing unit, a core, a main core, a sub-core, a processing area, a hardware engine, etc. or any component residing within, or external to, an integrated circuit within a portable computing device.

One of ordinary skill in the art will recognize that the term “MIPS” represents the number of millions of instructions per second a processor is able to process at a given power frequency. In this description, the term is used as a general unit of measure to indicate relative levels of processor performance in the exemplary embodiments and will not be construed to suggest that any given embodiment falling within the scope of this disclosure must, or must not, include a processor having any specific Dhrystone rating or processing capacity. Additionally, as would be understood by one of ordinary skill in the art, a processor's MIPS setting directly correlates with the power, frequency, or operating frequency, being supplied to the processor.

The present systems and methods for trace capture, extraction, and analysis by a subsystem of an SoC in a PCD provide a cost effective way to implement debugging for a subsystem of the SoC. An exemplary SoC will include performance analysis components for the SoC including hardware trace technology to capture and analyze instructions executed by the SoC also known as design for debug (DFD) structures. Such DFD structures allow the SoC to detect, capture, and debug errors in the operation of the SoC, whether during testing of the SoC or during operation of the SoC within a PCD operated by an end user.

Additionally, the SoC may include, one or more subsystem configured to operate in an internal or “power island” mode, independently from the rest of the SoC. Such subsystems may operate, for example when the rest of the SoC is in a low power mode, such as a non-functional, sleep, or zero-voltage state or mode. The subsystem may be for any number of purposes, including for example, monitoring a sensor of the SoC while the rest of the SoC is in a low power, non-functional, or zero-voltage state, allowing the sensor to be monitored without incurring the power cost of operating or waking up the entire SoC to monitor the sensor. Such exemplary subsystems may include a processor or DSP coupled to a sensor and/or a memory, or may include a state machine instead of the processor or DSP.

Since the subsystem will at times operate in the internal or power island mode, the DFD structures of the SoC will not be available to the subsystem to monitor, capture, and analyze errors in the operation of the subsystem. Instead of duplicating the memory and/or power intensive DFD structures of the SoC for each subsystem on the SoC that operates in a power island mode, the subsystem(s) include a trace buffer for capturing trace data, independent of the operation state of the rest of the SoC, and a hardware agent in communication with trace buffer. The hardware agent is configured to detect an error event or the occurrence of some other pre-configured hardware condition that may (or may not) be related to a hardware and/or software error or fault condition, and/or receive a communication about an error event when the subsystem is operating in, entering into, and/or exiting from an internal or power island mode.

During operation, in response to the error event, the hardware agent, either alone or in combination with other components of the subsystem causes the trace buffer to stop collecting trace data, ensuring that the trace data related to the error event on the subsystem is maintained in the buffer. The hardware agent may then send a message, signal, or interrupt to a power manager or other component of the SoC to bring the SoC to a full power mode and/or a state to allow the trace data in the subsystem trace buffer to be delivered to the SoC's DFD structure (or other desired destination, such as a test platform for the SoC and/or the PCD implementing the SoC). After the SoC is in a full power mode or a state that allows communications, the hardware agent causes the trace buffer to automatically deliver or send the trace data to the SoC's DFD structure (or other desired destination) for capture and/or analysis of the subsystem error event.

Once the trace data has been delivered to the SoC's DFD structure (or other desired destination), the hardware agent may also make a determination whether to reboot the subsystem and/or SoC or to allow the subsystem to continue operating. The hardware agent may also send a communication to the SoC power manager or other component of the SoC to effect this decision. The decision to continue operation could also mean that hardware agent must remove its request or vote for the SoC's debug or other resources in order to minimize the impact of the trace extraction process to the SOC execution timeline.

The present systems and methods allow for robust and flexible operation of subsystems of the SoC independently of the rest of the SoC, such as for routine checks of SoC sensors, without the need to keep the SoC fully operational and/or without the need to bring the SoC up from a low/reduced power mode or state. The present systems and methods allow such subsystems to operate independently, and to identify, capture, and recover from errors during the operation of such isolated subsystems when the SoC's DFD structures and/or other debugging or error analysis components are unavailable to the subsystem.

In one embodiment, the hardware agent and the trace buffer may be implemented as a single component. While in other embodiments, the hardware agent may be separate from the trace buffer. Additionally, in some embodiments, the subsystem may include additional components acting in conjunction with the hardware agent and/or trace buffer to allow the capture of trace data for the subsystem and the automatic communication of such trace data after an error event in the operation of the subsystem. By using a hardware device (or devices) for the hardware agent, it is possible for example to send interrupt signals and/or to ensure automatic communication of the trace data from the subsystem trace buffer, even if the error event has caused a processor or DSP of the subsystem to stall or become hung-up while waiting for the error event to resolve or complete.

The system for providing for trace capture, extraction, and analysis by a subsystem of an SoC in a PCD described herein, or portions of the system, may be implemented in hardware or software as desired. If implemented in hardware, the devices can include any, or a combination of, the following technologies, which are all well known in the art: discrete electronic components, an integrated circuit, an application-specific integrated circuit having appropriately configured semiconductor devices and resistive elements, etc. Any of these hardware devices, whether acting or alone, with other devices, or other components such as a memory may also form or comprise components or means for performing various operations or steps of the disclosed methods.

When a PCD or other system described herein is implemented, or partially implemented, in software, the software portion can be used to perform various steps of the methods described herein. The software and data used in representing various elements can be stored in a memory and executed by a suitable instruction execution system (microprocessor). The software may comprise an ordered listing of executable instructions for implementing logical functions, and can be embodied in any “processor-readable medium” for use by or in connection with an instruction execution system, apparatus, or device, such as a single or multiple-core processor or processor-containing system. Such systems will generally access the instructions from the instruction execution system, apparatus, or device and execute the instructions.

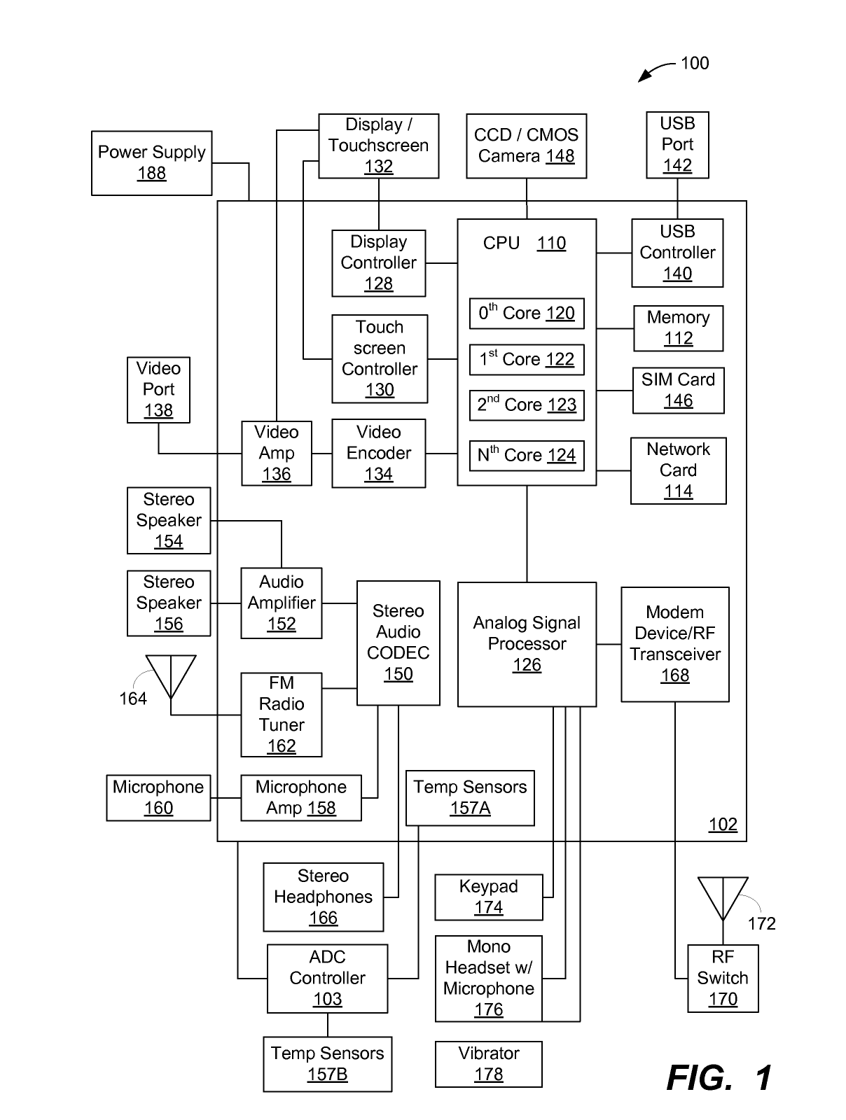

FIG. 1 is a block diagram of an exemplary, non-limiting aspect of a PCD 100 that may implement the present systems and methods in the form of a wireless telephone capable of communicating with one or more wireless communication system. Such wireless communication system may be a broadband wireless communication system, including a Long Term Evolution (LTE) system, a Code Division Multiple Access (CDMA) system, a Frequency Division Multiple Access (FDMA) system, a Global System for Mobile Communications (GSM) system, a wireless local area network (WLAN) system, some other wireless system, or a combination of any of these. A CDMA system may implement Wideband CDMA (WCDMA), CDMA 1X, Evolution-Data Optimized (EVDO), Time Division Synchronous CDMA (TD-SCDMA), or some other version of CDMA.

As shown, the PCD 100 includes an on-chip system (or SoC) 102 that includes a heterogeneous multi-core central processing unit (“CPU”) 110 and an analog signal processor 126 that are coupled together. The CPU 110 may comprise a zeroth core 120, a first core 122, second core 123, and an Nth core 124 as understood by one of ordinary skill in the art. Further, instead of a CPU 110, a digital signal processor (“DSP”) may also be employed as understood by one of ordinary skill in the art. Moreover, as is understood in the art of heterogeneous multi-core processors, each of the cores 120, 122, 123, 124 may process workloads at different efficiencies under similar operating conditions. Each of the cores 120, 122, 123, 124 may control one or more function of the PCD 100. For example, the first core 120 may be a graphics processing unit (GPU) for controlling graphics in the PCD 100. Such GPU/first core 120 may further include drivers and/or other components necessary to control the graphics in the PCD 100, including controlling communications between the GPU core 120 and memory 112 (including buffers). For another example, a different core such as the Nth core 124 may run the PCD operating system, such as a high-level operating system (HLOS). Such Nth/HLOS core 124 may further include drivers, hardware interfaces, and/or other components necessary to run the HLOS, including communications between the core 230 and memory 112 (which may include flash memory).

Any of the cores 120, 122, 123, 124 may be a separate processor such as a CPU or a digital signal processor. Additionally, each of the cores may be functionally grouped together with other components, such as memory 112, sensors, or other hardware of the PCD 100 to form a subsystem as described below. Such subsystem(s) may be implemented in order to perform certain functionality of the PCD, such as an audio subsystem, a GPS subsystem, a sensor subsystem, etc. One or more of such subsystems may also be configured to operate independently of the SoC 102, such as to continue operation when the SoC 102 has been placed into a low or reduced power state or mode, including a power off state or mode.

As illustrated in FIG. 1, a display controller 128 and a touch screen controller 130 are coupled to the multicore CPU 110. In turn, a display/touchscreen 132, external to the on-chip system 102, is coupled to the display controller 128 and the touch screen controller 130. A digital camera 148 may also be coupled to the multicore CPU 110. In such embodiments, the digital camera 148 may be controlled by one of the cores of the multicore CPU 110. In an exemplary aspect, the digital camera 148 is a charge-coupled device (CCD) camera or a complementary metal-oxide semiconductor (CMOS) camera

The PCD 100 of FIG. 1 may further include a video encoder 134, e.g., a phase alternating line (PAL) encoder, a sequential couleur a memoire (SECAM) encoder, or a national television system(s) committee (NTSC) encoder, or any other type of video decoder 134 coupled to the multicore CPU 110. Further, a video amplifier 136 is coupled to the video encoder 134 and the display/touchscreen 132. A video port 138 is coupled to the video amplifier 136. As depicted in FIG. 1, a universal serial bus (USB) controller 140 is coupled to the multicore CPU 110. Also, a USB port 142 is coupled to the USB controller 140. A memory 112 is also illustrated as coupled to the multicore CPU 110. Such memory 112 may for example be random access memory (RAM), read only memory (ROM), flash memory, or any combination thereof. A subscriber identity module (SIM) card 146 may also be coupled to the multicore CPU 110. In other embodiments, multiple SIM cards 146 may be implemented.

As further illustrated in FIG. 1, a stereo audio CODEC 150 may be coupled to the multicore CPU 110. Moreover, an audio amplifier 152 may be coupled to the stereo audio CODEC 150. In an exemplary aspect, a first stereo speaker 154 and a second stereo speaker 156 are coupled to the audio amplifier 152. FIG. 1 shows that a microphone amplifier 158 may be also coupled to the stereo audio CODEC 150. Additionally, a microphone 160 may be coupled to the microphone amplifier 158. In a particular aspect, a frequency modulation (FM) radio tuner 162 may be coupled to the stereo audio CODEC 150. Also, a FM antenna 164 is coupled to the FM radio tuner 162. Further, stereo headphones 166 may be coupled to the stereo audio CODEC 150.

FIG. 1 further indicates that a modem device/radio frequency (“RF”) transceiver 168 may be coupled to the multicore CPU 110. The modem device 168 may support one or more of the wireless communications protocols, such as GSM, CDMA, W-CDMA, TDSCDMA, LTE, and variations of LTE such as, but not limited to, FDB/LTE and PDD/LTE wireless protocols. Additionally, there may be multiple modem devices 168, and in such embodiments, different modem devices 168 may support come or all of the wireless communication protocols and/or technologies listed above.

In some implementations the modem device 168 may be further comprised of various components, including a separate processor, memory, and/or RF transceiver. In other implementations the modem device 168 may simply be an RF transceiver. Further, the modem device 168 may be incorporated in an integrated circuit. That is, the components comprising the modem device 168 may be a full solution in a chip and include its own processor and/or core that may be monitored by the systems and methods described herein. Alternatively, various components comprising the modem device 168 may be coupled to the multicore CPU 110 and controlled by one of the cores 120, 122, 124 of the CUP 110. An RF switch 170 may be coupled to the modem device 168 and an RF antenna 172. In various embodiments, there may be multiple RF antennas 172, and each such RF antenna 172 may be coupled to the modem device 168 through an RF switch 170.

As shown in FIG. 1, a keypad 174 may be coupled to the multicore CPU 110 either directly, or through the analog signal processor 126. Also, a mono headset with a microphone 176 may be coupled to the multicore CPU 110 and or analog signal processor 126. Further, a vibrator device 178 may also be coupled to the multicore CPU 110 and/or analog signal processor 126. FIG. 1 also shows that a power supply 188 may be coupled to the on-chip system 102, and in some implementations the power supply 188 is coupled via the USB controller 140. In a particular aspect, the power supply 188 is a direct current (DC) power supply that provides power to the various components of the PCD 100 that require power. Further, in a particular aspect, the power supply 188 may be a rechargeable DC battery or a DC power supply that is derived from an alternating current (AC) to DC transformer that is connected to an AC power source.

The multicore CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller 103. However, other types of thermal sensors 157 may be employed without departing from the scope of the disclosure.

FIG. 1 further indicates that the PCD 110 may also include a network card 114 that may be used to access a data network, e.g., a local area network, a personal area network, or any other network. The network card 114 may be a Bluetooth network card, a WiFi network card, a personal area network (PAN) card, or any other network card well known in the art. Further, the network card 114 may be incorporated in an integrated circuit. That is, the network card 114 may be a full solution in a chip, and may not be a separate network card 114.

As depicted in FIG. 1, the display/touchscreen 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, and the power supply 180 are external to the SoC 102.

The SoC 102 may also include various bus controllers (not shown). For example, a first example of a may be responsive to signals in the bus interface that communicatively couples the CPU 110 to components of a multimedia subsystem, including the video encoder 134. It should be understood that any number of similarly configured bus controllers can be arranged to monitor a bus interface arranged in the on-chip system 102. Alternatively, a single bus controller could be configured with inputs arranged to monitor two or more bus interfaces that communicate signals between CPU 110 and various subsystems of the PCD 100 as may be desired.

In a particular aspect, one or more of the method steps described herein may be enabled via a combination of data and processor instructions stored in the memory 112 and/or a memory located on the CPU 110. These instructions may be executed by one or more cores 120, 122, 123, 124 in the multicore CPU 110 and/or subsystems of the SoC 102 in order to perform the methods described herein. Further, the multicore CPU 110, one or more of the cores 120, 122, 123, 124, the memory 112, other components of the PCD 100, or a combination thereof may serve as a means for executing one or more of the method steps described herein in order enable external access detection and recovery by a subsystem of the SoC 102.

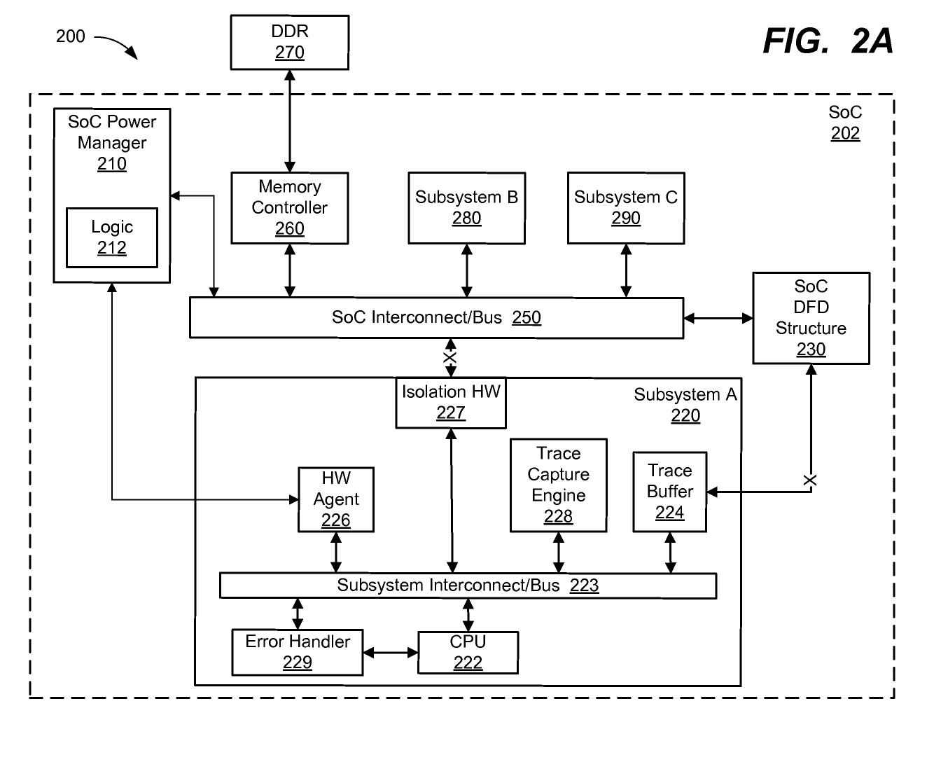

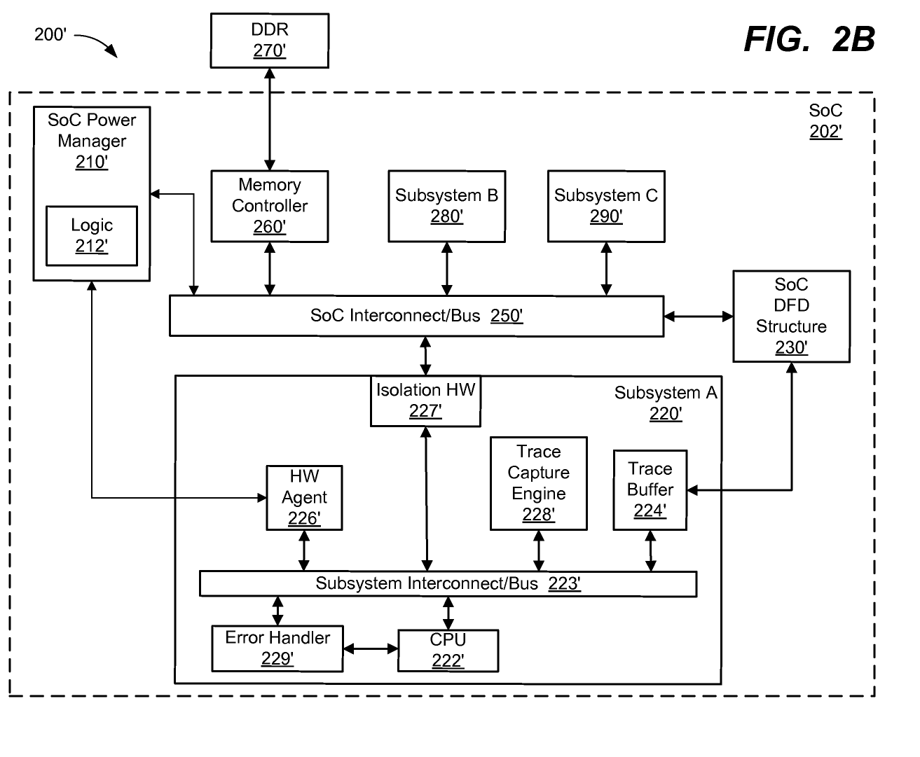

FIGS. 2A and 2B are block diagrams showing an exemplary embodiment of a system for trace capture, extraction, and analysis by a subsystem of an SoC in a PCD, such as the PCD embodiment illustrated in FIG. 1. FIGS. 2A and 2B illustrate the same embodiment of the exemplary system 200/200′ in differing operational states as discussed below. FIG. 2A illustrates the exemplary system 200 when the SoC 202 is in a non-functional, low power, or zero-voltage mode or state and Subsystem A 220 is operating independently. FIG. 2B illustrates the exemplary system 200′ when the SoC 202 is fully functional/powered or has been brought to a state where communications of trace data from Subsystem A 220′ to the relevant portions of the SoC 202′ (or other destinations) may be accomplished.

Starting with FIG. 2A, the exemplary system 200 includes a system-on-a-chip (SoC) integrated circuit 202, which could be implemented in a PCD (similar to the SoC 102 in FIG. 1). The SoC 202 of FIG. 2A includes a Subsystem A 220, Subsystem B 280, and Subsystem C 290 all connected to an SoC interconnect and/or bus 250. The SoC interconnect/bus 250 may be any desired type of bus or interconnect and may depend on the architecture of the SoC 202 and/or the uses for which the SoC 202 or PCD are intended.

The SoC 202 also includes a Memory Controller 260 in communication with the SoC interconnect/bus 250 and also in communication with a memory external to the SOC 202, DDR 280. Memory Controller 260 may control the access to various memories of the SoC 202, and also may allow the various components of the SoC 202, including Subsystem A 220, Subsystem B 280 and Subsystem C 290, to access the external DDR 280 memory when the SoC 202 is powered up and/or in a functional state or mode.

The SoC 202 also includes a Power Manager 210 that may contain internal Logic 212. The SoC Power Manager 210 enables the SoC 202 to enter into and exit out of various power modes or states, including various functional/full power modes or states and various non-functional or low power modes or states. Regardless of the functional state of the SoC 202, the SoC Power Manager 210 is always on/powered and able to wake up or power down the SoC 202 as desired according to the requirements of the PCD.

SoC 202 further includes design for debug (DFD) structures to assist in analysis of the performance of/debugging errors in the operation of the SoC 202. These DFD structures of the SoC 202 are represented in FIG. 2A by the box labeled SoC DFD Structure 230 illustrated as in communication with SoC interconnect/bus 250. As would be understood by one of ordinary skill in the art, such DFD structures for the SoC 202 may comprises multiple different hardware and/or software structures, to allow the SoC 202 and/or components or cores of the SoC 202 to be monitored, captured in data, analyzed, etc. to improve the performance of the SoC 202 and/or to assist in analyzing or debugging errors in the performance of the SoC 202. One example of such an SoC DFD Structure 230 could include one or more hardware traces coupled to one or more memories for storing trace data, along with logic for analyzing the trace data in accordance with one or more sets of instructions. All such DFD structures are intended to be within the scope of the SoC DFD Structure 230 that is illustrated as a box in FIG. 2A to ease in understanding FIG. 2A.

The exemplary Subsystem A 220 illustrated in FIG. 2A is in communication with the SoC interconnect/bus 250, SoC DFD Structure 230 and SoC Power Manager 210 as discussed below. In the embodiment illustrated in FIG. 2A, Subsystem A 220 is configured to be able to operate in an internal or power island mode, independently of the other portions of the SoC 202, including operating when the SoC 202 is in a low power and/or non-functional mode or state. In the FIG. 2A, Subsystem A 220 is in such an internal or power island mode or state, and communications between Subsystem A 220 and the SoC interconnect/bus 250 and SoC DFD Structure 230 have been disabled.

One or more of Subsystem B 280 and Subsystem C 290 (or additional subsystems not shown) in the illustrated embodiment may also be configured to operate independently of the other portions of the SoC 202 if desired. In such embodiments, Subsystems B 280 and C 290 may also include components (not shown for clarity) similar to those of Subsystem A 220 discussed below. In other embodiments, Subsystems B 280 and C 290 may be configured such that they are non-functional when the SoC 202 is in a low power and/or non-functional mode or state.

The exemplary Subsystem A 220 illustrated in FIG. 2A includes a processor, CPU 222, which could be implemented as one of the cores 120, 122, 123, 124 of FIG. 1. In some embodiments, the CPU 222 could be implemented as a general purpose processing unit, while in other embodiments the CPU 222 may be implemented as a dedicated processor, such as a DSP. The CPU 222 of Subsystem A 220 may also be in communication with one or more memories (not shown), sensors (not shown) or other components which are also functional and operational independently of the other portions of the SoC 202, including operating when the SoC 202 is in a low power and/or non-functional mode or state.

Subsystem A 220 also includes various isolation hardware represented by Isolation HW block 227 in FIG. 2A. The Isolation HW 226 serves to isolate Subsystem A 220 from the rest of the SoC 202 so that Subsystem A can continue to operate when the SoC 202 enters a low or zero power or voltage mode or state. In operation, the SoC 202 may for example enter into a non-functional and/or low or zero power or voltage mode or state, such as part a power savings routine. For example, as illustrated in FIG. 2A, when the SoC 202 is in a non-functional/low power mode or state, the Isolation HW 227 can operate to electrically isolate Subsystem A 220 (and its components) from the rest of the SoC 202 by isolating the connection with the interconnect/bus 250. Isolation HW 227 may include clamps and other hardware components necessary to achieve isolation from the rest of the SoC 202, including isolation from the SoC interconnect/bus 250, power rails, etc. of the SoC 202.

However, it may be desirable or required for the SoC 202 to periodically check sensors, such as sensors related to wireless connectivity, GPS connectivity or positioning, the accelerometer or gyros of the PCD to determine that a user is moving/operating the PCD, an audio sensor to detect a wake up sound or command such as from a user of the PCD, etc. Rather than periodically waking up the entire SoC 202 to perform such checks, Subsystem A 220 can continue to operate independently in a power island mode or internal mode electrically isolated from the rest of the SoC 202 while the SoC 202 is in the sleep, reduced power, or non-functional mode.

While operating in such a power island mode, Subsystem A 220 or a processor such as CPU 222 of Subsystem A can monitor the local sensor (not shown) and/or access the local memory (not shown). This power island mode of operation for Subsystem A 220 allows for the desired or necessary checking of the sensors/memories at a much lower power cost/consumption than continually waking up the SoC 202 before checking sensor 229. To assist in its operation, the illustrated Subsystem A 220 also includes a Subsystem interconnect/bus 223 in communication with the CPU 222 to provide communications with the other components of Subsystem A 220 when Subsystem A 220 is operating independently, such as in an internal or power island mode or state. The Subsystem interconnect/bus 223 may be a single bus/interconnect, or may comprise multiple busses or interconnects, such as an advanced high-performance bus (AHB) interconnect and/or advanced extensible interface (AXI) interconnect which may be used by various components of Subsystem A 220 for different types of communications as desired.

In various embodiments, Subsystem A 220 may include more or less components than illustrated in FIG. 2A. For example, the functionality of one or more of the components 224, 226, and/or 228 discussed below may be combined into fewer than the number of components illustrated, including into a single component. For another example, Subsystem A 220 may also include one or more sensors (not shown) and/or memories (not shown) to allow Subsystem A 220 to perform various desired functions of the SoC 202 or PCD while the rest of the SoC 202 is in a non-functional and/or low or zero voltage mode or state. Similarly, to allow operation when the rest of the SoC 202 is in a low power or zero power or voltage state or mode, Subsystem A 220 may also include a local power rail (not illustrated) in addition to the Subsystem interconnect/bus 223.

Additionally, in some embodiments, the components of Subsystem A 220 may be physically located near each other on the SoC 202, forming a physical subsystem of the SoC 202. In other embodiments, the components of Subsystem A 220 may be physically located apart from each other on the SoC 202, such that Subsystem A 220 illustrated in FIG. 2A represents a subsystem comprised of components located in varying physical locations on the SoC 202.

As illustrated in FIG. 2A, when Subsystem A 220 is operating in a power island or internal mode or state, Subsystem A 220 does not have the ability to communicate with the SoC DFD Structure 230 to monitor the operation of and/or handle or debug various errors in the operation of Subsystem A 220. The embodiment of Subsystem A 220 shown in FIG. 2A, therefore includes a trace buffer 224 for capturing trace information or data about the operation of Subsystem A 220 while Subsystem A 220 is operating in, going into, or exiting from a power island or internal mode or state. In implementations where Subsystem A 220 includes a CPU 222, the trace buffer 224 may collect trace data about the operation of the CPU 222. In other implementations, Subsystem A 220 may instead include a DSP or a state machine, and in such embodiments the trace buffer 224 may collect trace data about the operation of those components. The trace buffer 224 may be any buffer suitable for capturing such trace data, including trace data about the operation of CPU 222. The trace buffer 224 may be implemented for example in hardware as an embedded trace buffer (ETB) or embedded trace first-in-first-out (ETF) programmed in a circular buffer mode, or any other desired buffer. The trace buffer 224 may monitor the CPU 222 and/or collect trace data through the Subsystem interconnect/bus 223 or via a direct connection to the CPU 222 such as over a dedicated port from the CPU 222.

Subsystem A 220 also includes a hardware agent 226 which may be a separate component in communication with the trace buffer 224 as illustrated in FIG. 2A, or may be combined with the trace buffer 224 into one component in various embodiments. The hardware agent 226 operates to control the trace buffer 224 after certain events and/or to send or receive communications with the SoC Power Manager 210 after certain events when Subsystem A is operating in, going into, or exiting from a power island or internal mode or state. The hardware agent 226 is implemented at least in part in hardware. Exemplary implementations of the hardware agent 226 may include state machine, or as another component such as a DSP containing logic (including logic implemented in software and/or hardware).

The illustrated embodiment of Subsystem A 220 further includes a trace capture engine 228 in communication with the trace buffer 224. The trace capture engine 228 controls and/or assists the operation of the trace buffer 224 to capture trace data while Subsystem A 220 is operating in, going into, or exiting from a power island or internal mode or state. The trace capture engine 228 may be implemented in hardware, software, or both and in some embodiments may be one or more components separate from the trace buffer 224 and/or hardware agent 226. In other embodiments, the functionality or components of the trace capture engine 228 may be included within one or more of the trace buffer 224 and/or hardware agent 226.

For example, in some embodiments, the trace capture engine 228 may include logic to tell the trace buffer 224 to begin capturing trace data when Subsystem A 220 begins operating in, going into, or exiting from a power island or internal mode or state. While, in other embodiments, and depending on the architecture of Subsystem A 220, the trace capture engine 228 may comprise multiple components, including a trace stream interleaver to merge trace data from multiple trace busses (e.g. ARM's ATB bus)/interconnects on Subsystem A 220 to allow the trace data to be captured by trace buffer 224.

In various embodiments, the trace buffer 224, hardware agent 226, and trace capture engine 228 may comprise less (or more) than the three components illustrated in FIG. 2A, and the number of components may vary depending on the architecture of Subsystem A 220, SoC 202 and/or the PCD for which the SoC 202 is intended, as well as on the uses for which the SoC 202 and/or PCD are intended. In operation, (whether by a PCD end user or in testing by a PCD manufacturer) the trace buffer 224, hardware agent 226 and trace capture engine 228 allow for debug trace capture, extraction, and analysis when Subsystem A 220 is operating independently of the rest of the SoC 202.

When Subsystem A 220 of the SoC 202 begins to operate independently, such as in a power island mode or state, the trace capture engine 228 or hardware agent 226 sends a communication to the trace buffer 224 to begin capturing trace data for the CPU 222 of Subsystem A 220. Subsystem A 220 may operate in this power island mode for a variety of reasons, including when the SoC 202 is placed into a non-functional or low or zero power/voltage mode or state for power savings or in order to test Subsystem A 220. While Subsystem A 220 remains in this power island mode (including when Subsystem A 220 is entering into or exiting from this mode), the trace buffer 224 continues to collect this trace data. In some embodiments, the trace buffer 224 operates in circular buffer manner, overwriting the previous trace data, in order to keep trace data pertaining to the most recent operation of the CPU 222.

If during the operation of the CPU 222 a triggering event occurs, the trace buffer 224 stops collecting or saving trace data, ensuring that the trace data relating to and/or causing the triggering event is maintained in the trace buffer 224. In some embodiments, the triggering event may be one or more errors in the CPU's 222 execution of code, from which it has been previously determined that the CPU 222 will be unlikely to recover while Subsystem A 220 is operating in the power island mode or state. One such example may be a memory address error that causes the CPU 222 to attempt to write or read data from a memory external to Subsystem A 220 (such as DR 270) while Subsystem A 220 is in power island mode and does not have an active path to that external memory. In other embodiments, the triggering event may be any error by the CPU 222, or other component of Subsystem A 220, during its operation in a power island mode or state. In yet other embodiments, the triggering event may not be an error at all, but may be an event for which it is desirable to capture and evaluate trace data, such as for testing purposes by a PCD manufacturer for example.

The triggering event may be any desired trigger, such as a software exception, hardware trigger, local watchdog notification, etc., and the triggering event may be detected in a variety of manners in different embodiments. For example, in one embodiment, an error handler 229 or other component in communication with the CPU 222 may identify or detect the triggering event, such as by a software exception. In such implementations of this embodiment, the error handler 229 may then either directly or indirectly cause the trace buffer 224 to stop collecting trace data. For example, upon detecting the triggering event, the error handler 229 may send a communication to the trace buffer 224 to stop collecting or saving trace data.

Alternatively, upon detecting the triggering event, the error handler 229 may act indirectly, such as by a communication to another component like the hardware agent 226 and/or trace capture engine 228 to cause the other component(s) to stop trace data from being sent to or otherwise being collected/saved by the trace buffer 224. In yet other implementations, any time the error handler 229 detects an error it may notify the hardware agent 226, and the hardware agent 226 may identify or determine whether or not the error is a triggering event that would warrant causing the trace buffer 224 to stop collecting/saving trace data. In such implementations, the hardware agent 226 may make such determination by any desired means.

In other embodiments, the hardware agent 226 may itself detect or identify the triggering event, which may be a software exception, watchdog notification, or hardware trigger/“wiggle” that the hardware agent 226 is preconfigured to detect regardless of whether the event is an error. In such embodiments, the hardware agent 226 upon detecting or receiving notification of the event may directly cause the trace buffer 224 to stop collecting or saving trace data such as through a communication sent to the trace buffer 224. In other implementations of this embodiment, the hardware agent 226 may instead indirectly cause the trace buffer 224 to stop collecting or saving trace data. Such indirect action by the hardware agent 226 may include a communication to another component, such as the trace capture engine 228, to cause the other component to stop trace data from being sent to or otherwise being collected/saved by the trace buffer 224.

Regardless of how it is accomplished, the trace buffer 224 will stop collecting or saving trace data to ensure that the trace data related to/leading up to the triggering event is not overwritten. Once such trace capture in the trace buffer 224 is complete, the hardware agent 226 sends a signal, such as an interrupt or other communication (e.g. a vote or request for a set of SoC 202 recources or components required for trace data forwarding) or notification to the SoC Power Manager 210. Such communication or notification tells the SoC Power Manager 210 to begin waking up the SoC 202 to allow Subsystem A 220 to access the SoC DFD Structure 230 or other components of the SoC 202 (or external to the SoC 202).

The SoC Power Manager 210 may include Logic 212 that allows the SoC Power Manager 210 to interpret the signal or communication from the hardware agent 226. In some embodiments, upon receiving the signal the SoC Power Manager 210 may operate to cause only the portions of the SoC 202 necessary to complete the access by the Subsystem A 220 to the SoC DFD Structure 230 to become powered/operational. In these embodiments, the signal or communication from the hardware agent 226 may include information that the SoC Power Manager 210 interprets, such as using Logic 212, to determine the components of the SoC 202 needed to complete the access. In other embodiments, upon receiving the signal from the hardware agent 226, the SoC Power Manager 210 operates to cause the entire SoC 202 to restore to a functional and/or powered state or mode.

In addition to sending the signal to the SoC Power Manager 210, the hardware agent 226 may also cause Subsystem A 220 to transition to a non-power island/regular functional mode such that Subsystem A 220 can communicate with the rest of the SoC 202 including the SoC DFD Structure 230. In embodiments, the hardware agent 226 Monitor Module 224 may send a signal such as an interrupt to cause the Isolation HW 227 to re-enable communications with the interconnect/bus 250 or other busses Subsystem A 220 and/or the trace buffer 224 to access other portions of the SoC 202 including the SoC DFD Structure 230. Other examples could include the hardware agent, or other components causing other hardware to re-connect Subsystem A 220 to the SoC 202 power rail to support increased activity of Subsystem A 220 and/or the components of Subsystem A 220.

In this manner, upon the detection of the triggering event (regardless of how the detection is accomplished), the hardware agent 226 causes the trace data causing/leading up to the triggering event to be preserved in the trace buffer 224, and causes the SoC 202 to power up and Subsystem A 220 to exit the power island mode (at least to the extent necessary to communicate with the SoC DFD Structure 230). These actions may be especially beneficial for embodiments of Subsystem A 220 that do not have a CPU 222, but instead are implemented with a DSP or a state machine. In such implementations, if the triggering event is an error the DSP or state machine may not have the ability to exit Subsystem A from the power island mode or state (or to attempt to recover from the error), without the hardware agent 226 sending the communication to the SoC Power Manager 210 as discussed above. This ability to re-power the SoC 202 and/or Subsystem A 220 after an error event, as well as ensure capture of the trace data leading to the event for analysis and debugging, is beneficial for both testing of the PCD including the SoC 202, as well as preventing crashes/hang-ups of the SoC 202 when in use by an end user.

Turning to FIG. 2B the system 200′ is illustrated after the SoC 202′ has been awakened and/or is operating at full power. As illustrated in FIG. 2B, the connection(s) between Subsystem A 220′ and the SoC 202′ have been restored, such as by disabling the Isolation HW 227′. The restored connections between the SoC 202′ and the Subsystem A 220′ include communications between the trace buffer 224′ and the SoC DFD Structure 230′.

In some embodiments, when the SoC 202′ or desired components or pathways of the SoC 202, have returned to full power/a functional state the hardware agent 226′ may receive a signal, such as an acknowledgement (ACK) from the SoC Power Manager 210, that the desired communications between Subsystem A 220 and the SoC 202 have been restored. In other embodiments, the hardware agent 226′ may receive a signal or communication from within Subsystem A 220′ that such communications have been restored (or hardware agent 226′ may be able to detect such restored communications itself). Once the hardware agent 226′ detects/receives such notice, the hardware agent 226′ causes the trace data in the trace buffer 224′ to be pushed out of or sent from the trace buffer 224 and out of Subsystem A 220′.

In some implementations, the destination for the trace data may be the SoC DFD Structure 230 to allow the SoC DFD Structure 230 to capture and analyze the trace data for the triggering event, such as for example to identify the occurrence of a pre-determined hardware event, to assist in debugging if the event was an error, etc. In other implementations, the destination for the trace data may be another source such as an external DR 270, a USB port, or even a network connection to allow the trace data for the triggering event to be captured and/or analyzed remotely, such as by a remote testing/debugging platform with which the PCD is in communication. The destination for the trace data may be selected or set at the hardware agent 226 in some embodiments. In other embodiments, the hardware agent 226 may just automatically push the trace data to the SoC DFD Structure 230 which may deliver the trace data in turn to another location such as the DR 270, a USB port, or a network connection.

The hardware agent 226 may receive some indication or acknowledgement, such as from the SoC DFD structure 230, that all of the forwarded trace data from the trace buffer 224 has been received at the desired destination. Once the trace buffer 224 has delivered the trace data and such trace data has been received at the destination, the hardware agent 226 determines whether to ask the SoC 202 and/or PCD to reboot or to ask the system to continue with normal operations. Such determination may be made by the hardware agent 226 based on a variety of factors, including whether or not the PCD is being operated in a testing mode or as part of an operational test of the PCD. In such implementations where the PCD is being tested, such as by the PCD manufacturer, it may be desirable to have the PCD reboot and re-enter Subsystem A 220 into the power island mode many times, or many thousands of times in order to test all possible triggering events and/or how often various triggering events may happen for Subsystem A 220. In such implementations, it may also be desirable to have the PCD continue normal operations and allow another subsystem, such as Subsystem B 280 or Subsystem C 290 enter into a power island mode to see whether such other subsystems experience any triggering events.

Thus, in various embodiments, the hardware agent 226 can be configured to: take various considerations into account and make a determination of whether to cause a reboot based on a variety of factors; to cause the PCD/SoC 202 to automatically reboot upon certain triggering events; to cause the PCD/SoC 202 to automatically reboot (or to reboot “X” number of times) regardless of the triggering event; to allow the PCD/SoC 202 to continue normal operations upon certain triggering events to see if other subsystems will replicate the event; to always allow the PCD/SoC 202 to continue normal operations (such as if the PCD is in service with an end user) to allow debugging by the SoC DFD Structure 230 to occur; etc. as desired.

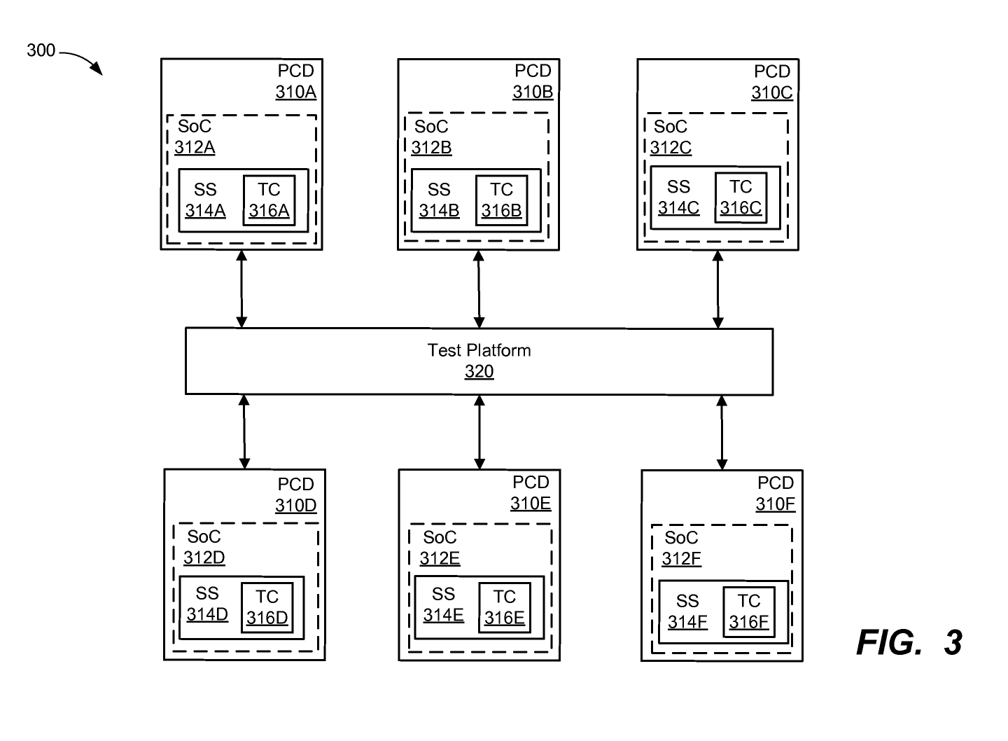

FIG. 3 is a block diagram of illustrating another exemplary embodiment of a system 300 for trace capture, extraction, and analysis by a subsystem of an SoC in multiple PCDs. Similar to the embodiment illustrated in FIGS. 2A and 2B, the system 300 of FIG. 3 includes multiple PCDs 310A-310F containing SoC 312A-312F, respectively. In some embodiments, one or more of the multiple PCDs 310A-31F are in close proximity to and may be physically connected to the test platform 320. In other embodiments one or more of the multiple PCDs 310A-310F may be remotely located from, and connected through a network such as a telecommunications network to the test platform 320.

The SoCs 312A-312F may each be similar to the SoC 202/202′ discussed above for FIGS. 2A-2B. Each of SoC 312A-312F includes at least one Subsystem (SS) 314A-314F that is similar to Subsystem A 220/220′ of FIGS. 2A-2B. However, note that the components illustrated for each SoC 312A-312F are illustrative. In some embodiments, each of SoC 312A-312F will include the same number of subsystems, while in other embodiment's one or more of SoC 312A-312F may have differing numbers of subsystems. Additionally, in some embodiments, each of SS 314A-314F will include a CPU like CPU 222/222′ while in other embodiments one or more subsystem SS 314A-314F may instead have a DSP or a state machine rather than a CPU.

Each subsystem SS 314A-314F is configured with trace capture TC 316A-316F similar to the trace capture functionality discussed above for FIGS. 2A-2B, including at least a trace buffer 224/224′ and hardware agent 226/226′. In some embodiments, one or more of trace capture TC 316A-316F may also include trace capture engine 228/228′ discussed above. In some embodiments, all of the trace captures TC 316A-316F of the subsystems SS 314A-314F may be configured in the same manner. In other embodiments, the trace captures TC 316A-316F of the subsystems SS 314A-314F may be configured differently. For example, in one embodiment TC 316A may include a trace buffer 224, hardware agent 226, and trace capture engine 228 as three or more separate components, while TC 316B may implement the hardware agent 226 as a subcomponent or portion of the trace buffer 224, and TC 316C may implement trace buffer 224 separately, but combine trace capture engine 228 and hardware agent 226 into one component. Other configurations are also possible as would be understood by one of ordinary skill in the art.

Each of PCD 310A-310F is in communication with test platform 320 which, as discussed above, may serve as the destination for trace data collected by TC 316A-316F. Test platform 320 may include one or more memories (not shown) for storing received trace data from PCD 310A-310F, as well as one or more processors (not shown) for executing software or instructions to collect and/or analyze the received trace data. One example of such software is DAP, a statistics program for data management.

System 300 allows trace data to be gathered and analyzed by the test platform 320 for multiple subsystems SS 314A-314F operating in any desired testing conditions, through any desired number of iterations of power island mode entry/operation, implementing any desired parameters or configurations for the subsystems SS 314A-314F or trace captures TC 316A-316F, and/or over any desired period of time for the testing. In this manner the trace capture TC 316A-316F functionality, like the functionality discussed above in FIGS. 2A-2B allows for a cost effective way to test and/or debug multiple subsystems SS 314A-314F as they operate in power island modes or states under any desired conditions or configurations.

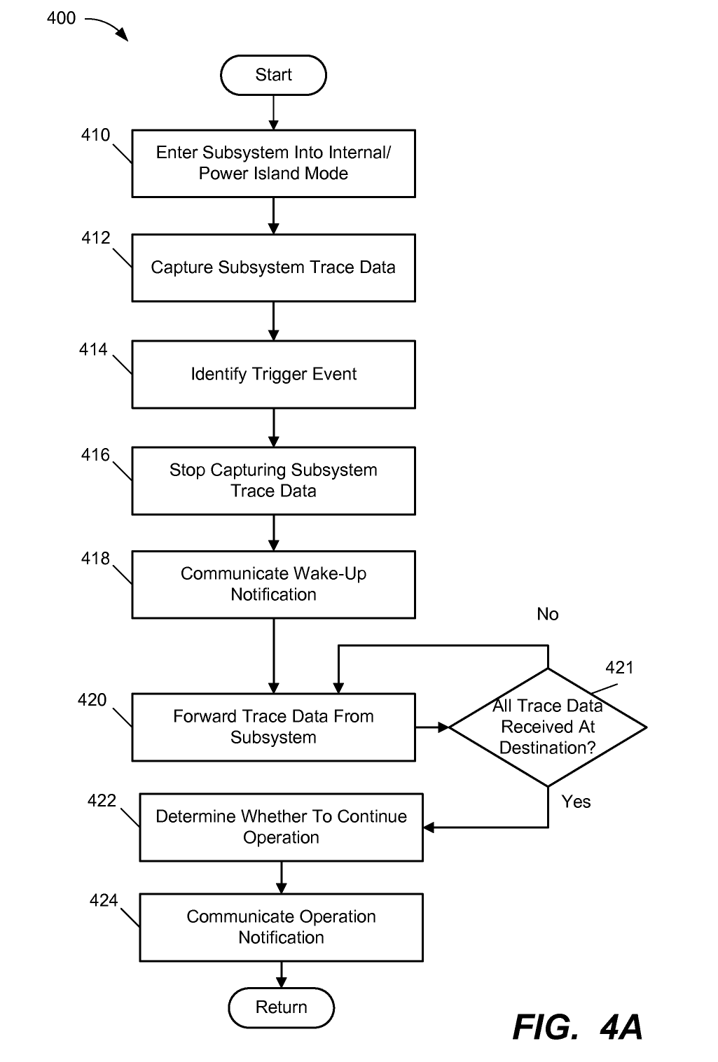

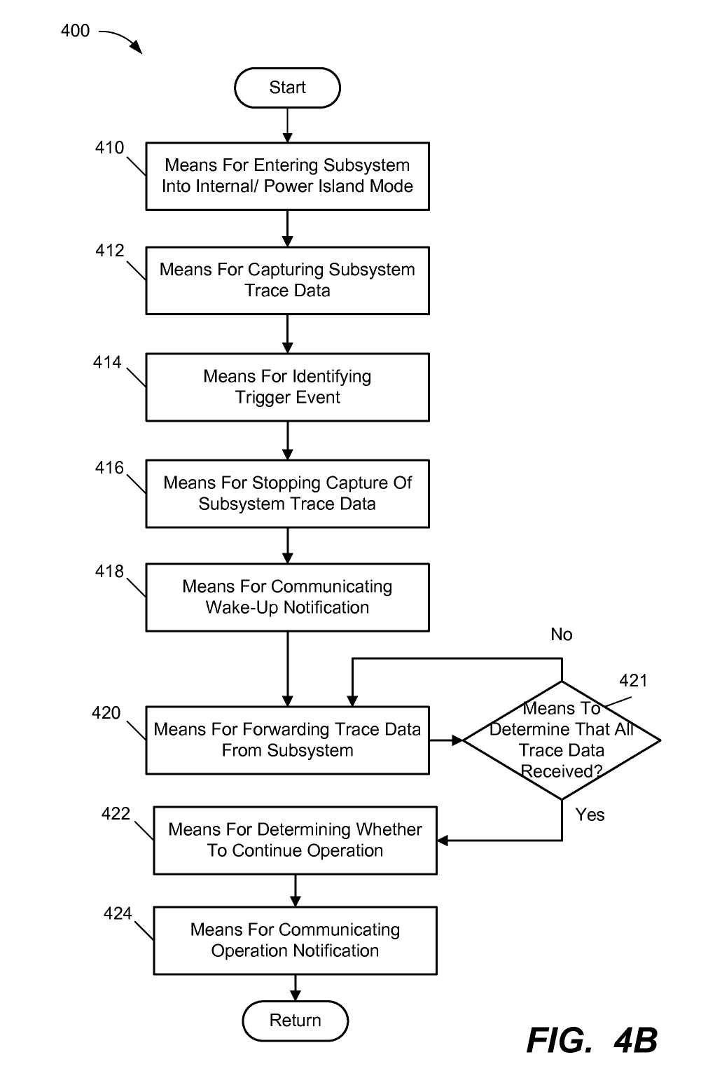

Turning to FIG. 4A a flowchart describing aspects of an exemplary embodiment of a method 400 for providing trace capture, extraction, and analysis by a subsystem of an SoC is illustrated. The subsystem of method 400 may be a subsystem such as Subsystem A 220/220′ located on an SoC such as SoC 202/202′ of FIGS. 2A-2B. The method 400 begins with block 410 where a subsystem enters into an internal/power island mode. Using the system 200 of FIG. 2A as an example, such power island mode or state allows Subsystem A 220 to operate independently of the SoC 202. The subsystem in block 410 may enter the internal /power island mode or state for testing purposes or as a result of the SoC 202 in an operating PCD going into a non-functional or low or zero power or voltage mode (for example as part of a power savings algorithm or process).

As the subsystem begins entering into the power island mode or state, and while the subsystem operates in that mode or state, trace data for the subsystem is captured in block 412. Such trace data includes data about the operation of the subsystem, including a processing unit or DSP operating in the subsystem. The trace data may be captured in a memory or buffer of the subsystem that operates while the subsystem is in the power island mode. Continuing with the example of FIG. 2A, the trace data may be data about the operation of the CPU 222 that captured by, and stored in, trace buffer 224. In some embodiments, the trace buffer 224 may be configured to automatically begin storing trace data when Subsystem A 220 enters into the power island mode. In other embodiments, trace buffer 224 may be controlled by another component, such as hardware agent 226 or trace capture engine 228 to begin storing trace data as Subsystem A 220 enters into, and operates in, a power island mode or state.

In block 414 a trigger event is identified. Such trigger event may be a particular type of error in the operation of the subsystem (or a component of the subsystem), may be any error in the operation of the subsystem (or a component of the subsystem), or may be any event for or about which it is desired to capture trace data (even if not an error at all). Returning to the example of FIG. 2A, in some embodiments the trigger event may be identified by a component such as an error handler 229 in communication with the CPU 229 either acting by itself or in conjunction with another component such as hardware agent 226. For example, the error handler 229 may identify an event or error in the operation of the CPU 222. In such implementations, the error handler 229 may itself identify or determine that the event/error as a trigger event or the error handler 229 may send a signal about the event to another component such as hardware agent 226 that identifies the event/error as a trigger event.

In other embodiments, the trigger event may identified directly by the hardware agent 226. In such embodiments, the hardware agent 226 may receive or identify a signal about an event that the hardware agent 226 is preconfigured to detect or identify at a triggering event, regardless of whether the event is an error. Such signal may include a software exception, watchdog notification, or hardware trigger/“wiggle” in various implementations.

In block 416 the method 400 stops capturing subsystem trace data once the trigger event is identified. In embodiments where the error handler 229 identifies the trigger event the error handler 229 may then either directly or indirectly cause the trace buffer 224 to stop collecting trace data. For example, upon detecting the triggering event, the error handler 229 may send a communication to the trace buffer 224 to stop collecting or saving trace data. Alternatively, upon detecting the triggering event, the error handler 229 may act indirectly, such as by a communication to another component like the hardware agent 226 and/or trace capture engine 228 to cause the other component(s) to stop trace data from being sent to or otherwise being collected/saved by the trace buffer 224.

In other embodiments where the hardware agent 226, either by itself or in conjunction with another component identifies the trigger event, the hardware agent 226 may directly cause the trace buffer 224 to stop collecting or saving trace data such as through a communication sent to the trace buffer 224. In other implementations of these embodiments, the hardware agent 226 may instead indirectly cause the trace buffer 224 to stop collecting or saving trace data. Such indirect action by the hardware agent 226 may include a communication to another component, such as the trace capture engine 228, to cause the other component to stop trace data from being sent to or otherwise being collected/saved by the trace buffer 224.

The trace buffer 224 stops collecting or saving trace data in block 416 to ensure that the trace data related to/leading up to the triggering event is not overwritten. Once such data is captured in the trace buffer 224, a wake-up notification is communicated in block 418. Using the example of FIG. 2A, in some embodiments, the hardware agent 226 of Subsystem A 220 may send a signal, such as an interrupt or other communication or notification to an always-on SoC Power Manager 210 of the SoC 202. The signal from the hardware agent 226 notifies the SoC Power Manager 210 to begin waking up the SoC 202 to allow Subsystem A 220 access to the SoC 202 (or SoC interconnect/bus 250).

In some embodiments communicating the wake-up notification may additionally or alternatively comprise sending a wake-up communication to one or more components of the subsystem to transition the subsystem to a state where it may communicate with the SoC. Again referring to FIG. 2A, the hardware agent 226 or other component of Subsystem A 220 may send a signal or other communication to the isolation hardware 227 to disable and/or to bring Subsystem A 220 to a state or mode where it may communicate with the SoC 202 and/or components of the SoC 202 such as the SoC DFD Structure 230.

In yet other embodiments, communicating the wake-up notification may additionally comprise sending a second signal or communication from the SoC to the subsystem acknowledging that the SoC has been awakened and/or that the desired SoC communication pathways have been enabled. For example, in the embodiment of FIG. 2A, the SoC power Manager 210 may send a communication such as an ACK back to the hardware agent 226 or other component of Subsystem A 220. The ACK may, acknowledge that the desired communication pathways on, or components of the SoC, including for example the SoC DFD Structure 230 has been placed into a powered/functional state and is able to receive communications.

The method 400 in block 420 then forwards the captured trace data from the subsystem. As discussed above for FIG. 2A, the hardware agent 226 may automatically cause the trace buffer 224 to communicate the trace data in the trace buffer 224 to a particular destination, such as the SoC DFD Structure for capture of the trace data on the SoC for analysis and/or debugging. In other embodiments, the hardware agent 226 may cause the trace data in the trace buffer 224 to be forwarded to another destination, such as DR 270, a USB port of the PCD, or to a communications network for forwarding to a remote location such as test platform 330 of FIG. 3. In various implementations, the hardware agent 226 may include logic to determine the appropriate destination for the trace data, or the hardware agent 226 may be set to cause the trace data to be sent to a remote location such as test platform 330 of FIG. 3 (such as when the method 400 is being used to test one or more SoCs).

At block 421, the method 400 determines whether all of the trace data sent from the subsystem in block 420 has been received at the desired destination. If all of the trace data has not been received, the method 400 continues forwarding the trace data in accordance with block 420. If all of the trace data has been received, the method 400 proceeds to block 422. The determination in block 421 may be made by any means desired, such as by a communication or acknowledgement to the hardware agent 226, such as from the SoC DFD Structure 230 or other component, that all trace data has been received.

When the trace data has finished forwarding from the subsystem, a determination may be made in block 422 whether to continue operation. In some embodiments the determination of block 422 may be made by the hardware agent 226, and may be a determination of whether to ask the SoC 202 and/or PCD to reboot or to ask the system to continue with normal operations. Such determination may be made by the hardware agent 226 based on a variety of factors, including whether or not the PCD is being operated in a testing mode or as part of an operational test of the PCD.

In various embodiments, the hardware agent 226 or other component of Subsystem A can be configured to: use logic to take various considerations into account and make a determination of whether to cause a reboot based on a variety of factors; to cause the PCD/SoC 202 to automatically reboot upon certain triggering events; to cause the PCD/SoC 202 to automatically reboot (or to reboot “X” number of times) regardless of the triggering event; to allow the PCD/SoC 202 to continue normal operations upon certain triggering events to see if other subsystems will replicate the event; to always allow the PCD/SoC 202 to continue normal operations (such as if the PCD is in service with an end user) to allow debugging by the SoC DFD Structure 230 to occur; etc. as desired.

In block 424 the determination of block 422 is communicated to the SoC. Using the above example, if the determination of block 422 is made by the hardware agent 226, the hardware agent 226 may send a signal to the SoC Power Manager 210 to either continue normal operations or reboot the SoC 202 (or Subsystem A 220) depending on what has been previously determined. Continuing with normal operations may include, for example, removing or cancelling the request or vote from the hardware agent 226 for the SoC DFD Structure 230 resources in order to minimize the impact of the trace extraction process to the SoC 202 execution or operation timeline. The method 400 will then return.

As would be understood by one of ordinary skill in the art, FIG. 4A describes only one exemplary embodiment of the disclosed methods 400. In other embodiments, additional blocks or steps may be added to the methods 400 illustrated in FIG. 4A Similarly, in some embodiments various blocks or steps shown in FIG. 4A be combined or omitted. Such variations of the methods 400 are within the scope of this disclosure.

Additionally, certain steps in the processes or process flows described in this specification, including FIG. 4A may naturally precede others for the invention to function in the embodiments as described. However, the disclosure is not limited to the order of the steps described if such order or sequence does not alter the functionality of the invention. Moreover, it is recognized that some steps may performed before, after, or in parallel (substantially simultaneously) with other steps without departing from the scope of the disclosure.

Additionally, in some instances, certain steps may be omitted or not performed without departing from the invention. Such variations of the methods 400 are also within the scope of this disclosure. Further, words such as “thereafter”, “then”, “next”, “subsequently”, etc. are not intended to limit the order of the steps. These words are simply used to guide the reader through the description of the exemplary method.

The various operations, methods, or functions described above for methods 400 may be performed by various hardware and/or software component(s)/module(s). Such component(s) and/or module(s) may provide the means to perform the various described operations, methods, or functions. Generally, where there are methods illustrated in Figures having corresponding counterpart means-plus-function Figures, the operation blocks correspond to means-plus-function blocks with similar numbering. For example, blocks 410-424 illustrated in FIG. 4A correspond to means-plus-function blocks 410′-424′ illustrated in FIG. 4B.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed processor-enabled processes is explained in more detail in the above description and in conjunction with the drawings, which may illustrate various process flows.

In one or more exemplary aspects as indicated above, the functions described may be implemented in hardware, software, firmware, or any combination thereof. If implemented in software, the functions may be stored on or transmitted as one or more instructions or code on a computer-readable medium, such as a non-transitory processor-readable medium. Computer-readable media include both data storage media and communication media including any medium that facilitates transfer of a program from one location to another.

A storage media may be any available media that may be accessed by a computer or a processor. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

Although selected aspects have been illustrated and described in detail, it will be understood that various substitutions and alterations may be made herein without departing from the present invention, as defined by the following claims.

What is claimed is:

1. A method for trace extraction for a subsystem of a system-on-a-chip (SoC) in a portable computing device (PCD), the method comprising:
operating the subsystem of the SoC independently of the rest of the SoC, the subsystem comprising a hardware agent in communication with a trace buffer;
capturing a trace data about the operation of the subsystem with the trace buffer;
identifying a trigger event; and
in response to the identified trigger event:
stop capturing the subsystem trace data, and
communicating a wake-up notification, the wake-up notification comprising a signal from the hardware agent to the SoC.

2. The method of claim 1, wherein:
the subsystem further comprises a processor, and
capturing trace data about the operation of the subsystem further comprises capturing trace data about the operation of the processor.

3. The method of claim 2, wherein identifying the trigger event further comprises one of identifying an error in the operation of the processor with the hardware agent, identifying the occurrence of a pre-determined hardware condition, identifying a hardware fault, or identifying the occurrence of a pre-determined software condition.

4. The method of claim 1, wherein the hardware agent is a state machine.

5. The method of claim 4, wherein the hardware agent is located internal to the trace buffer.

6. The method of claim 1, wherein:
communicating the wake-up notification further comprises receiving an acknowledgement from the SoC to the hardware agent, and
in response to the received acknowledgement, automatically sending the trace data from the subsystem.

7. The method of claim 6, wherein automatically sending the trace data from the subsystem further comprises sending the trace data from the trace buffer to a test platform remotely located from the PCD.

8. A computer system for a system-on-a-chip (SoC) in a portable computing device (PCD), the system comprising:
a subsystem of the SoC configured to operate independently of the rest of the SoC, the subsystem comprising:
a trace buffer configured to capture a trace data about the operation of the subsystem, and
a hardware agent in communication with the trace buffer, the hardware agent configured to identify a trigger event and in response to the identified trigger event:
cause the trace buffer to stop capturing the subsystem trace data, and
communicate a wake-up notification to the SoC.

9. The system of claim 8, wherein:
the subsystem further comprises a processor, and
capturing trace data about the operation of the subsystem further comprises capturing trace data about the operation of the processor.

10. The system of claim 9, wherein the trigger event comprises one of identifying an error in the operation of the processor with the hardware agent, identifying the occurrence of a pre-determined hardware condition, identifying a hardware fault, or identifying the occurrence of a pre-determined software condition.

11. The system of claim 8, wherein the hardware agent is a state machine.

12. The system of claim 11, wherein the hardware agent is located internal to the trace buffer.

13. The system of claim 8, wherein:
communicating the wake-up notification further comprises receiving an acknowledgement from the SoC to the hardware agent, and
in response to the received acknowledgement, the hardware agent causes the trace data to be sent from the subsystem.

14. The system of claim 13, wherein the hardware agent causes the trace data to be sent from the trace buffer to a test platform remotely located from the PCD.

15. A computer program product comprising a non-transitory computer usable medium having a computer readable program code embodied therein, said computer readable program code adapted to be executed to implement a method for trace extraction for a subsystem of a system-on-a-chip (SoC) in a portable computing device (PCD), the method comprising:
operating the subsystem of the SoC independently of the rest of the SoC, the subsystem comprising a hardware agent in communication with a trace buffer;
capturing a trace data about the operation of the subsystem with the trace buffer;
identifying a trigger event; and
in response to the identified trigger event:
stop capturing the subsystem trace data, and
communicating a wake-up notification, the wake-up notification comprising a signal from the hardware agent to the SoC.

16. The computer program product of claim 15, wherein:
the subsystem further comprises a processor, and
capturing trace data about the operation of the subsystem further comprises capturing trace data about the operation of the processor.

17. The computer program product of claim 16, wherein identifying the trigger event further comprises one of identifying an error in the operation of the processor with the hardware agent, identifying the occurrence of a pre-determined hardware condition, identifying a hardware fault, or identifying the occurrence of a pre-determined software condition.

18. The computer program product of claim 15, wherein the hardware agent is located internal to the trace buffer.

19. The computer program product of claim 15, wherein:
communicating the wake-up notification further comprises receiving an acknowledgement from the SoC to the hardware agent, and
in response to the received acknowledgement, automatically sending the trace data from the subsystem.

20. The computer program product of claim 19, wherein automatically sending the trace data from the subsystem further comprises sending the trace data from the trace buffer to a test platform remotely located from the PCD herein the component external to the subsystem is a memory.
